(19) United States
(12) Patent Application Publication
(10) Pub. No.: US 2012/0200391 A1
(43) Pub. Date: Aug. 9, 2012

(54) METHOD TO IDENTIFY USER WITH SECURITY

(75) Inventors: Nobukazu Sugiyama, San Diego, CA (US); Djung Nguyen, San Diego, CA (US); Abhishek Patil, San Diego, CA (US)

(73) Assignee: SONY CORPORATION, A JAPANESE CORPORATION, Tokyo (JP)

(21) Appl. No.: 13/238,017

(22) Filed: Sep. 21, 2011

Related U.S. Application Data
(60) Provisional application No. 61/439,202, filed on Feb. 3, 2011.

(51) Int. Cl. G06F 7/04

(52) U.S. Cl. 340/5.82; 340/5.8

(57) ABSTRACT

The present invention is directed toward a system and method for identifying and authenticating a user using one or more types of pattern information. Specifically, the present invention provides a convenient user identification and authentication method using pattern information from one or more sources including (1) an audio-input device, (2) an optical-input device and/or (3) an orientation sensing device.

The present Application claims priority to U.S. Provisional Application No. 61/439,202, filed Feb. 3, 2011, entitled “THE METHOD TO IDENTIFY USER WITH SECURITY”, which is incorporated herein by reference.

### FIELD OF THE INVENTION

The present invention pertains generally to a method and apparatus for identifying and authenticating a user. More specifically, the present invention relates to a user verification method that utilizes pattern information to identify and authenticate a user for access to one or more processor-based devices such as a personal computer (PC) or tablet PC.

### BACKGROUND OF THE INVENTION

Computers have become indispensable tools for both personal and work related uses. As such, processor-based devices such as computers and tablet PC devices have become ubiquitous in both home and office environments. As such, it is increasingly common that use of a single PC or tablet PC device will be shared among multiple users, e.g., members of a common office area or household.

### SUMMARY OF THE INVENTION

Several embodiments of the invention advantageously address the needs above as well as other needs by providing a processor-based device comprising: A system comprising: a touch-sensitive display screen electrically coupled to a processor; an audio-input device electrically coupled to the processor; an optical-input device electrically coupled to the processor; an orientation sensing device electrically coupled to the processor, wherein the orientation sensing device comprises one or more accelerometers; and wherein the processor is configured to perform steps comprising: receiving pattern information from at least one of, (i) the touch-sensitive display screen; (ii) the audio-input device; (iii) the optical-input device; or (iv) the orientation sensing device; determining an identity of a user, from among a plurality of users, based at least in part on received pattern information; authenticating the user, based at least in part on the received pattern information; and retrieving a user profile specific to the user based on the determined user identity.

In another embodiment, the invention may be characterized as a method comprising the steps of: receiving pattern information from at least one of, (i) a touch-sensitive display screen; (ii) an audio-input device; (iii) an optical-input device; or (iv) an orientation sensing device; determining an identity of a user, from among a plurality of users, based at least in part on received pattern information; authenticating the user, based at least in part on the received pattern information; and retrieving a user profile specific to the user based on the determined user identity.

In yet another embodiment, the invention can be characterized as a tangible non-transitory computer readable medium storing one or more computer readable programs adapted to cause a processor based system to execute steps comprising: receiving, via a network, pattern information from a client device, wherein the pattern information comprises information from at least one of, (i) a touch-sensitive display screen; (ii) an audio-input device; (iii) an optical-input device; or (iv) an orientation sensing device; determining an identity of a user, from among a plurality of users, based at least in part on received pattern information; authenticating the user, based at least in part on the received pattern information; transmitting, via the network, a verification response to the client device based on a determined identity and authentication of the user.

### BRIEF DESCRIPTION OF THE DRAWINGS

FIG. 1 is a block diagram illustrating a processor-based system 100 that may be used to run, implement and/or execute the methods and/or techniques shown and described herein in accordance with some embodiments of the invention;

FIG. 2 is a flow diagram of a method for identifying and authenticating a user and then retrieving a user profile, according to some embodiments of the invention;

FIG. 3 is a flow diagram of a method for receiving validation pattern information from a user and then identifying and authenticating the user based on the received validation pattern information, according to some embodiments of the invention;

FIG. 4 illustrates a system for remotely identifying and authenticating a user, according to some embodiments of the invention;

FIG. 5 is a flow diagram of a method for remotely identifying and authenticating a user, according to some embodiments of the invention.

### DETAILED DESCRIPTION

Reference will now be made in detail to certain embodiments of the present disclosure, examples of which are illustrated in the accompanying figures. It is to be understood that the figures and descriptions of the present disclosure illustrate and describe elements that are of particular relevance to the present disclosure, while eliminating, for the sake of clarity, other elements found in typical personal computer and/or tablet PC systems. As such, the following descriptions are not to be taken in a limiting sense, but are made merely for the purpose of describing the general principles and exemplary embodiments of the instant invention. The scope of the invention should be determined with reference to the claims.

Furthermore, reference throughout this specification to “one embodiment,” “an embodiment,” or similar language means that a particular feature, method-step, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

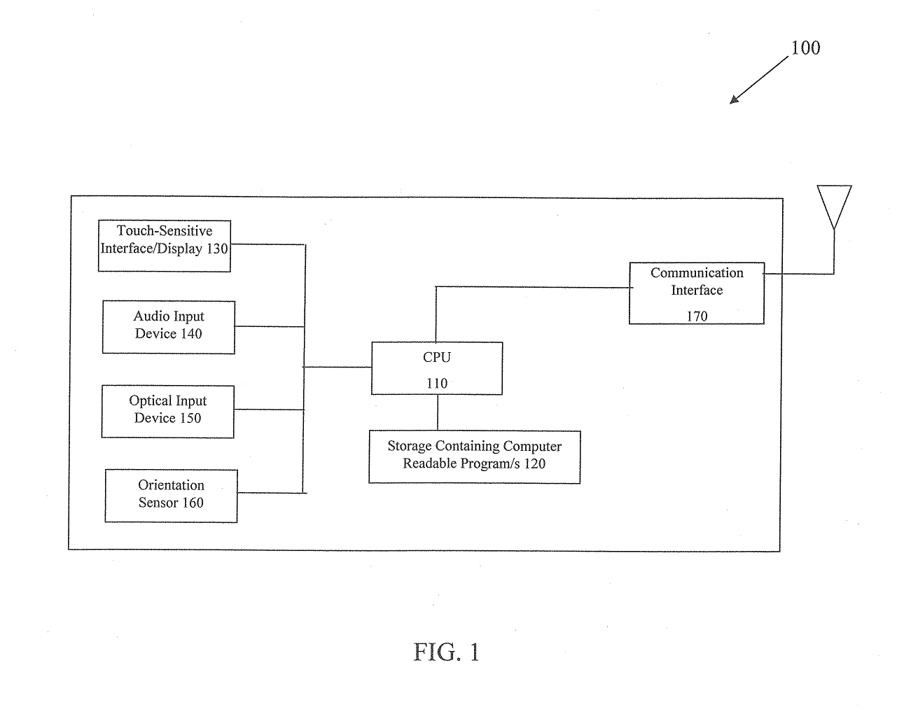

FIG. 1 illustrates a system 100 for carrying out some embodiments of the invention; however as would be understood by one of skill in the art, the techniques described herein may be utilized, implemented and/or run on many different types of processor-based systems. As illustrated in FIG. 1, the system 100 comprises: a central processing unit (CPU) 110, a storage device 120 (e.g., a tangible non-transitory memory device such as a disk drive or flash memory device etc.), a touch-sensitive interface/display 130, an audio input device 140, an optical input device 150, an orientation sensor 160 and a communication interface 170. As would be appreciated by those of skill in the art, the system 100 may comprise essentially any processor-based computing device, including but not limited to one or more: personal computers, console game systems, tablet PC devices, televisions (TVs), entertainment systems, mobile phones, PDAs, etc.

Furthermore, the storage device 120 may comprise essentially any type of tangible non-transitory memory device and may optionally include external memory and/or removable storage media such as a digital video disk (DVD), Blu-ray disc, compact disk (CD) and/or one or more magnetic or flash-based memory devices such as a USB storage device or other tangible non-transitory memory device, etc. By way of example, the storage device 120 may be used for storing software code that implements the methods and techniques described herein.

In some embodiments of the invention, the communication interface 170 will comprise a communication port for establishing communication and exchanging information with one or more other processor-based systems. By way of example, the communication interface 170 may comprise one or more wired or wireless devices for transmitting and receiving information. In some embodiments, the communication interface 170 will comprise a wireless device and will use an antenna for use in transmitting and receiving information from one or more other processor based systems or devices and/or one or more networks, such as the internet.

As illustrated, the storage device 120, touch sensitive interface/display 130, audio input device 140, optical input device 150, orientation sensor 160 and communication interface 170 are all electrically coupled to the CPU 110. In some embodiments of the invention, each of the touch sensitive interface/display 130, audio input device 140, optical input device 150, orientation sensor 160 and communication interface 170 will be configured to receive pattern information from one or more users for use in identifying and authenticating the one or more users in accordance with the methods further discussed below.

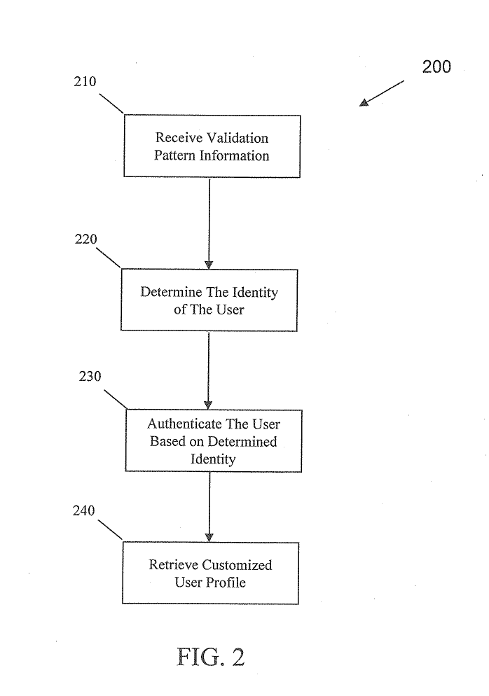

FIG. 2 illustrates a flow diagram of a method 200 for determining the identity of a user and authenticating the user, according to several embodiments of the invention.

The method 200 begins in step 210 in which a processor-based system (e.g., the system 100 illustrated in FIG. 1) receives validation pattern information from a user. As would be appreciated by those of skill in the art, the validation pattern information may be received via one or more input devices (e.g., the touch sensitive interface/display 130, audio input device 140, optical input device 150 and/or orientation sensor 160) and may comprise pattern information corresponding to a variety of user inputs including (but not limited to), touch-based patterns or signatures, spoken words/phrases, user gestures and/or patterns of movement made to the processor-based device (e.g., a tablet PC, mobile phone or mobile computing device).

In step 220, the identity of the user is determined, based at least in part on the pattern information received in step 210, as discussed above. In step 230, the user is authenticated based at least in part on the user's identity (determined in step 220) as well as based at least in part on the pattern information received in step 210. Thus, in some embodiments, the received pattern information serves to both identify and verify a user's login to the processor-based device.

By way of example, the received pattern information may comprise a spoken phrase unique to a particular user such as “wake up tablet.” Thus, when the correct user supplies the proper login credentials (e.g., by uttering the words “wake up tablet”), the user will be first identified (i.e., in step 220) and then authenticated in step 230. Thus, upon the entering of a single validation pattern, (e.g., the phrase “wake up tablet”) the user may be both identified and authenticated.

Proceeding to step 240, upon identification and authentication of the user, the processor-based system may then load and/or retrieve customized user settings and/or preference information unique to a user. For example, upon identifying and authenticating the user (as described above with respect to steps 220 and 230) one or more user specific profiles may be retrieved/loaded that contain setting and appearance information unique to the user.

In some embodiments, a user's saved password credentials (i.e., login and password information) for one or more websites and/or applications may also be loaded/retrieved upon successful identification and authentication of the user, as described above with respect to steps 220 and 230. By way of example, upon providing the proper validation pattern information, the user's stored login/password information may be automatically loaded (e.g., into the user name and password prompts of a webpage) so that the user may freely access multiple web accounts, files and/or applications without the need to manually provide further identification or authentication information. Thus, the method 200 provides a means by which a user may easily provide identification and authentication information at login, without the need to provide any additional authentication credentials afterward.

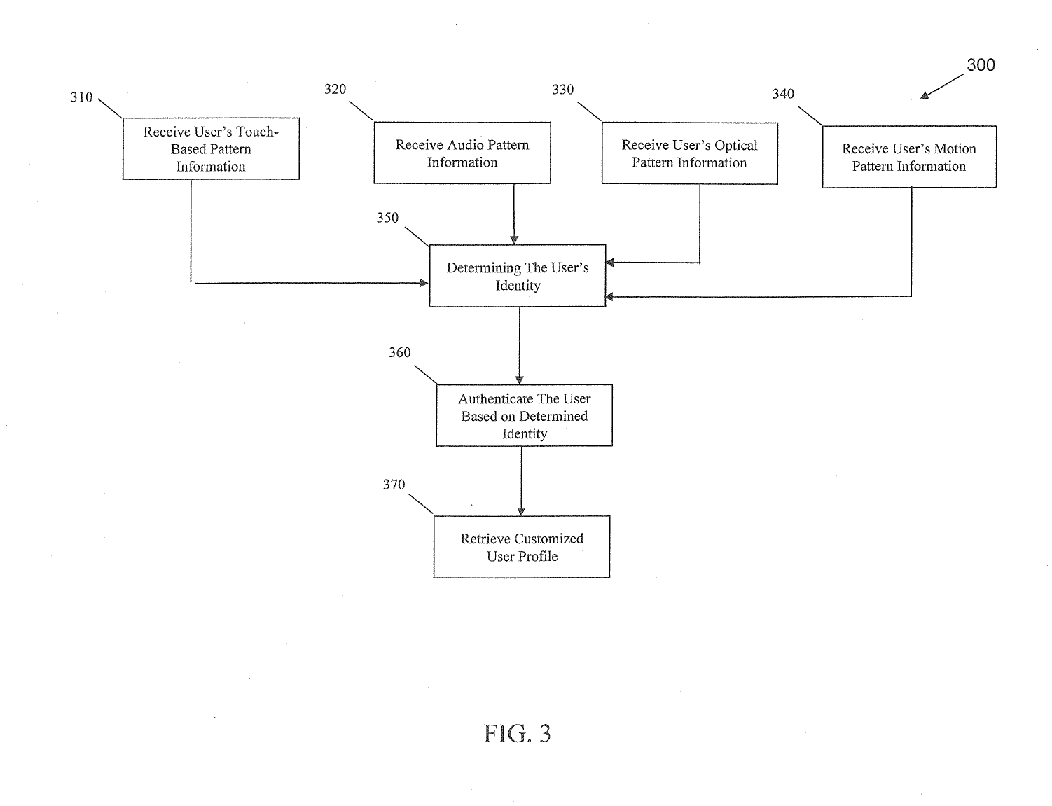

FIG. 3 illustrates a method 300 by which various types of validation pattern information can be received from a user for use in identification and authentication. The method 300 begins with optional step 310 in which a processor based system (e.g., the system 100 of FIG. 1) receives touch-based pattern information from a user, e.g., via one or more tactile input devices (such as the touch sensitive input/display 130 of the system 100 described above). As would be appreciated by those of skill in the art, tactile pattern information may be received via one or more devices including (but not limited to), one or more touch-pads and/or touch sensitive displays, etc. By way of example, the validation pattern information may comprise information pertaining to a pattern drawn on the touch sensitive input/display 130; for example, a pattern drawn by the user using his/her fingers. In some embodiments, the user's signature information will be received via a touch sensitive input or display (e.g., the touch sensitive interface/display 130 of the system 100) using a stylus or similar input device. For example, the tactile pattern information may comprise a signature of the user, etc.

In some embodiments, the validation pattern information may comprise audible pattern information. In optional step 320 audible pattern information is received from the user via one or more audio input devices (e.g., microphones). As would be appreciated by those of skill in the art, the audible pattern information may comprise essentially any sound information that may be used to identify and authenticate a user. However, in some embodiments, the audible pattern information may comprise one or more words or phrases spoken by the user. For example, a particular user's correct validation pattern may comprise audio pattern information corresponding to the phrase “it's a sunny day.” In some embodiments, the system (e.g., the system 100 of FIG. 1) will be configured to perform voice characteristic analysis to determine the user's identity, etc., based on an analysis of the received audible pattern information. Thus, based on the receipt of these words “it's a sunny day” by the correct user the processor-based system can identify and authenticate the user and log him/her into a computing session, as described in further detail below.

In optional step 330, the system (e.g., the system 100 of FIG. 1) may receive optical pattern information from the user. In some embodiments, the optical pattern information will be received via one or more cameras, motion sensors and/or charge-coupled devices (e.g., CCD sensors). However, as would be appreciated by those of skill in the art, optical pattern information may be received from essentially any device capable of providing optical output information related to the user. In some embodiments, the optical pattern information may comprise information related to one or more visual features of the user. By way of example, the optical pattern information may comprise information pertaining to the user's facial features or some other physical aspect that may be unique to a particular user. By way of further example, in some embodiments, the optical pattern information may comprise a gesture or motion made by the user.

In optional step 340, a user may enter motion pattern information via one or more orientation sensors (e.g., the orientation sensor/s 160 of the system 100). In some embodiments, the orientation sensors may comprise one or more tilt sensors and/or accelerometers; however, essentially any sensor capable of detecting movement and position changes may be used. By way of example, the processor-based system may store one or more unique motion patterns for use in verifying a user; thus when motion pattern information is entered by a user (e.g., by moving/tilting the processor-based device) the user may be validated, as described in further detail below.

In some embodiments, the validation pattern information used to identify and authenticate the user will only comprise information from one of steps 310, 320, 330 or 340 discussed above; that is, the validation pattern information will comprise only tactile pattern information, audio pattern information, optical pattern information or orientation pattern information. However, in some embodiments, the validation pattern information may comprise information from any number of (or all of), the types of validation pattern information in steps 310, 320, 330 and 340, discussed above. By way of example, a user's validation pattern information may comprise audio pattern information (e.g., a spoken phrase) accompanied by motion pattern information (e.g., moving the processor-based device/tablet PC in a certain motion upon entering).

In step 350, the identity of the user is determined, based at least in part on the validation pattern information received in any number of (or all of) optional steps 310, 320, 330 and/or 350, as discussed above. In step 360, the user is authenticated based at least in part on the user's identity (determined in step 350) as well as based at least in part on the validation pattern information received in steps 310-350. Thus, in some embodiments, the received pattern information serves to both identify and verify a user's login to the processor-based device.

Proceeding to step 370, upon identification and authentication of the user, the system may then load and/or retrieve customized user settings and/or preference information unique to a user. For example, upon identifying and authenticating the user one or more user specific profiles may be retrieved/loaded that contain setting and appearance information unique to the user. Thus, in some embodiments, the user's validation pattern information may provide an alternative identification and authentication means such that it will be unnecessary for the user to provide separate login (i.e., username) and password credentials. As would be appreciated by those of skill in the art, in some embodiments multiple validation patterns may be registered with respect to one or more user's for a single processor-based device allowing multiple users to share a single device (e.g., a tablet PC or entertainment system) while enabling the convenient loading of a particular user's profile and/or setting information upon login. In some embodiments, the user's personal preferred setting/profile information may comprise, but is not limited to, the user's personal display settings and options. However, in some embodiments, access to a user's profile will include access to user specific data such as stored files, bookmarks etc.

Similar to that discussed above with respect to step 240 of the method 200, in some embodiments, a user's saved password credentials (i.e., login and password information) for one or more websites and/or applications may also be loaded/retrieved upon successful identification and authentication of the user, as described above with respect to steps 350 and 360. By way of example, upon providing the proper validation pattern information, the user's stored login/password information may be automatically loaded (e.g., into the user name and password prompts of a webpage) so that the user may freely access multiple web accounts, files and/or applications without the need to manually provide further identification or authentication information. Thus, the method 300 provides a means by which a user may easily provide identification and authentication information at login, without the need to provide any additional authentication credentials thereafter.

Additionally, as would be appreciated by those of skill in the art, a user's login credentials may be used to determine settings which govern rights to one or more applications or content types. For example, a user's identification and authentication (determined based on one or more information types as described in steps 310-340) may dictate whether or not an authenticated user may access a particular type of content (such as adult content, content of a certain parental rating, etc.) or may access discrete content items, such as specific web page/s and/or application/s. By way of example, the confinement of user access may be implemented by failing to process one or more commands, e.g., by failing to process certain voice commands by users lacking requisite access rights.

In some aspects of the invention, the system may determine access rights with respect to the identity of the user issuing a command without need for consideration of which authenticated user initiated the computing session. By way of example, a parent may be logged into a user session allowing a child to browse various content items within that session. However, each command issued by the child may be verified against the child's access rights before the system proceeds. For example, if the child issues a voice command to access a particular application or content item, the system will first identify the owner of the voice command (i.e., the child) and then make a determination as to whether the owner is permitted to execute that command (i.e., whether the child is permitted access to the one or more requested content items).

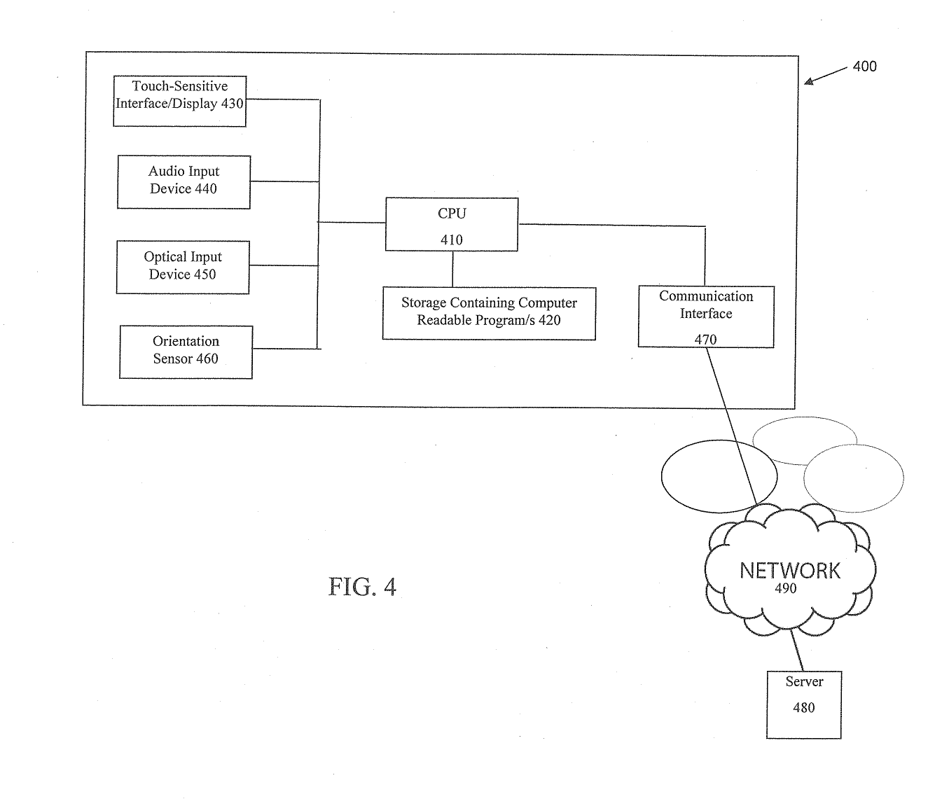

FIG. 4 illustrates a system 400 for carrying out some embodiments of the invention; however as would be understood by one of skill in the art, the techniques described herein may be utilized, implemented and/or run on many different types of processor-based systems. As illustrated in FIG. 4, the system 400 comprises: a central processing unit (CPU) 410, a storage device 420 (e.g., a tangible non-transitory memory device such as a disk drive or flash memory device, etc.), a touch-sensitive interface/display 430, an audio input device 440, an optical input device 450, an orientation sensor 460, a communication interface 470, a server 480 and a network 490.

The storage device 420 may comprise essentially any type of tangible non-transitory memory device and may optionally include external memory and/or removable storage media such as a digital video disk (DVD), Blu-ray disc, compact disk (CD) and/or one or more magnetic or flash-based memory devices such as a USB storage device or other tangible non-transitory memory device, etc. By way of example, the storage device 420 may be used for storing code that implements the methods and techniques described herein.

In some embodiments, the communication interface 470 will comprise a communication port for establishing communication and exchanging information with one or more other processor-based systems, e.g., via the network 490. By way of example, the communication interface 470 may comprise one or more wired or wireless devices for transmitting and receiving information. In some embodiments, the communication interface 470 will comprise a wireless device and will use an antenna for use in transmitting and receiving information from one or more other processor based systems (e.g., the server 480) or devices and/or one or more networks (e.g., the network 490), such as the internet.

Furthermore, in some embodiments, the processor-based device 400 is further coupled to a network via either a wired or wireless connection. Additionally, some embodiments of the network 490 will be in further communication with one or more other processor-based devices (e.g., the server 480).

As illustrated, the storage device 420, touch sensitive interface/display 430, audio input device 440, optical input device 450, orientation sensor/s 460 and communication interface 470 are all electrically coupled to the CPU 410. In some embodiments of the invention, each of the touch sensitive interface/display 430, audio input device 440, optical input device 450 and orientation sensor 460 will be configured to receive pattern information from one or more users for use in identifying and authenticating the one or more users in accordance with the methods further discussed below.

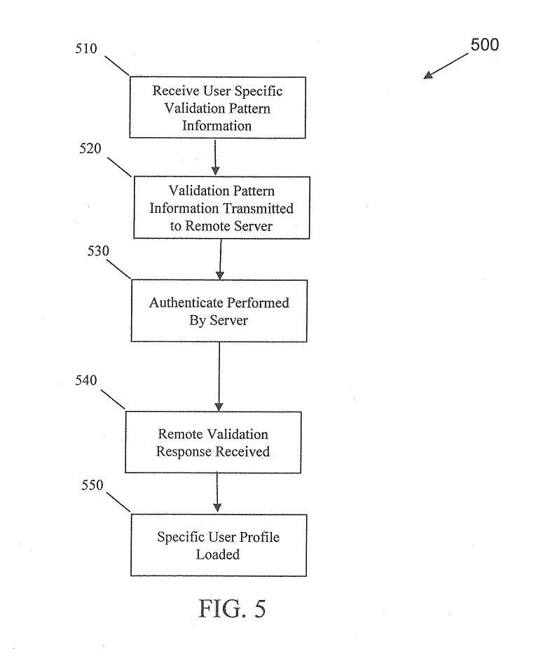

FIG. 5 illustrates a method 500 for remotely validating a user, according to several embodiments of the invention. The method 500 begins in step 510 in which a processor-based system (e.g., the system 100 illustrated in FIG. 1) receives validation pattern information from a user. As would be appreciated by those of skill in the art, the validation pattern information may be received via one or more input devices (e.g., the touch sensitive interface/display 130, audio input device 140, optical input device 150 and/or orientation sensor 160) and may comprise pattern information corresponding to a variety of user inputs including (but not limited to), touch-based patterns and/or signatures, spoken words/phrases, user gestures and/or patterns of movement made to the processor-based device (e.g., a tablet PC, mobile phone or mobile computing device).

In step 520, validation pattern information is transmitted to a remote server (e.g., the server 480 of the system 400) via a communication interface (e.g., the communication interface 470 of the system 400). In step 530, the user is validated (i.e., identified and authenticated), at the remote server based at least in part on the pattern information received in step 510, as discussed above.

In step 530, a remote validation response is received from the remote server indicating whether the user has been properly identified and authenticated. If the remote validation response indicates that the user cannot be properly identified and/or authenticated, then the user is denied system access. In some embodiments, the failure to validate the user will result in a prompt for the user to re-enter his/her validation pattern information (e.g., by returning to step 510 of the method 500). However, if the remote validation response indicates that the user has been validated, the process proceeds to step 550 in which the user is logged into the computing session. In some embodiments, upon successfully logging into the system, the user's unique profile and/or setting information will be automatically loaded.

In some embodiments, a user's saved password credentials (i.e., login and password information) for one or more websites and/or applications may also be loaded/retrieved upon successful verification of the user by the remote server. By way of example, upon ascertaining the user's identification and authentication credentials, the user's stored login/password information may be automatically loaded (e.g., into the user name and password prompts of a webpage) so that the user may freely access multiple web accounts, files and/or applications without the need to manually provide further identification or authentication information. Thus, the method 500 provides a means by which a user may easily provide identification and authentication information at login, without the need to provide any additional authentication credentials afterward.

In some embodiments, the user's validation pattern information may be used to identify and authenticate the user for accounts/services held outside of the work or home environment. By way of example, the user's unique validation pattern information may be used to validate the user for access to areas in the public space such as banks, sport clubs, etc.

1. A system comprising:
a touch-sensitive display screen electrically coupled to a processor;
an audio-input device electrically coupled to the processor;
an optical-input device electrically coupled to the processor;
an orientation sensing device electrically coupled to the processor,
wherein the orientation sensing device comprises one or more accelerometers; and
wherein the processor is configured to perform steps comprising:
receiving pattern information from at least one of,
(i) the touch-sensitive display screen;
(ii) the audio-input device;
(iii) the optical-input device; or
(iv) the orientation sensing device;
determining an identity of a user, from among a plurality of users, based at least in part on received pattern information;
authenticating the user, based at least in part on the received pattern information; and
retrieving a user profile specific to the user based on the determined user identity.

2. The system of claim 1, wherein the received pattern information comprises information received from the touch-sensitive display screen; and
wherein the information received from the touch-sensitive display screen comprises data representing a touch pattern on the touch-sensitive display screen.

3. The system of claim 2, wherein the touch pattern comprises a signature of the user.

4. The system of claim 1, wherein the received pattern information comprises information received from the audio-input device; and
wherein the information received from the audio-input device comprises data representing one or more words spoken by the user.

5. The system of claim 1, wherein the received pattern information comprises information received from the optical-input device; and
wherein the information received from the optical-input device comprises data representing one or more gestures made by the user.

6. The system of claim 1, wherein the received pattern information comprises information received from the orientation sensing device; and
wherein the information received from the orientation sensing device comprises data representing one or more movements made by the user.

7. The system of claim 1, wherein the received pattern information comprises information received from at least two of the following: (i) the touch-sensitive display screen; (ii) the audio-input device; (iii) the optical-input device; or (iv) the orientation sensing device.

8. The system of claim 1, wherein the received pattern information comprises information received from at least three of the following: (i) the touch-sensitive display screen; (ii) the audio-input device; (iii) the optical-input device; or (iv) the orientation sensing device.

9. The system of claim 1, wherein the received pattern information comprises information received from at least four of the following: (i) the touch-sensitive display screen; (ii) the audio-input device; (iii) the optical-input device; and (iv) the orientation sensing device.

10. The system of claim 1, further comprising:
a network device electrically coupled to the processor, wherein the processor is further configured for receiving a remote authentication response received via the network device; and
wherein the authenticating the user is further based at least in part on the remote authentication response.

11. A method comprising:
receiving pattern information from at least one of,
(i) a touch-sensitive display screen;
(ii) an audio-input device;
(iii) an optical-input device; or
(iv) an orientation sensing device;
determining an identity of a user, from among a plurality of users, based at least in part on received pattern information;
authenticating the user, based at least in part on the received pattern information; and
retrieving a user profile specific to the user based on the determined user identity.

12. The method of claim 11, wherein the received pattern information comprises information received from the touch-sensitive display screen; and
wherein the information received from the touch-sensitive display screen comprises data representing a touch pattern on the touch-sensitive display screen.

13. The method of claim 11, wherein the received pattern information comprises information received from the audio-input device; and
wherein the information received from the audio-input device comprises data representing one or more words spoken by the user.

14. The method of claim 11, wherein the received pattern information comprises information received from the optical-input device; and
wherein the information received from the optical-input device comprises data representing one or more gestures made by the user.

15. The method of claim 11, wherein the received pattern information comprises information received from the orientation sensing device; and
wherein the information received from the orientation sensing device comprises data representing one or more movements made by the user.

16. The method of claim 11, wherein the received pattern information comprises information received from at least two of the following: (i) the touch-sensitive display screen; (ii) the audio-input device; (iii) the optical-input device; or (iv) the orientation sensing device.

17. The method of claim 11, wherein the received pattern information comprises information received from at least three of the following: (i) the touch-sensitive display screen; (ii) the audio-input device; (iii) the optical-input device; or (iv) the orientation sensing device.

18. The method of claim 11, wherein the received pattern information comprises information received from at least four of the following: (i) the touch-sensitive display screen; (ii) the audio-input device; (iii) the optical-input device; and (iv) the orientation sensing device.

19. The method of claim 11, further comprising:
receiving a remote authentication response via a network device;
wherein the authenticating the user is further based at least in part on the received remote authentication response.

20. A tangible non-transitory computer readable medium storing one or more computer readable programs adapted to cause a processor based system to execute steps comprising:
receiving, via a network, pattern information from a client device,
wherein the pattern information comprises information from at least one of,
(i) a touch-sensitive display screen;
(ii) an audio-input device;
(iii) an optical-input device; or
(iv) an orientation sensing device;
determining an identity of a user, from among a plurality of users, based at least in part on received pattern information;
authenticating the user, based at least in part on the received pattern information;
transmitting, via the network, a verification response to the client device based on a determined identity and authentication of the user.
